(19) United States
(12) Patent Application Publication
(10) Pub. No.: US 2006/0076755 A1
(43) Pub. Date: Apr. 13, 2006

(54) Automatic hitch system

(76) Inventor: Renald Bergeron, Quebec (CA)

Correspondence Address: Mr. Renald Bergeron, 116, Route 165 Sud, Ste-Sophie, QC, GOP 1LO, CA

(21) Appl. No.: 10/962,797

(22) Filed: Oct. 13, 2004

(51) Int. Cl. B60D 1/36

(52) U.S. Cl. 280/509; 280/477

(57) ABSTRACT

An automatic hitch system which is capable to automatically couple or uncouple a pulling vehicle with a trailing vehicle without the need of the driver to get out of the pulling vehicle. The automatic hitch system comprises a first hitch section to be mounted on a pulling vehicle to be hitched to a second hitch section mounted on a trailing vehicle, and which allow the automatic positioning, coupling and uncoupling of the pulling vehicle with respect to the trailing vehicle. The first hitch section of the invention comprises a bottom channel to receive the extending tongue portion of the pulling vehicle. The bottom channel includes at its lower end a lever with contact flanges to fold up the foot member of the second hitch section underneath the extending drawbar of the trailing vehicle during the coupling operation.

### BACKGROUND OF THE INVENTION

1. Field of the Invention

The present invention relates to a hitch system for hitching a trailing vehicle to a pulling vehicle, in which a first hitch section is mounted on the forwardly extending tongue of the pulling vehicle and a second hitch section is mounted on the forwardly extending drawbar portion of the trailing vehicle, and in which the first hitch section can be automatically coupled and uncoupled from the second hitch section.

2. Description of the Related Art

Many coupling systems have been developed for providing a connection between a trailing vehicle and a pulling vehicle. The manual coupling and uncoupling of a trailing vehicle to a pulling vehicle is inconvenient when the driver of the pulling vehicle is alone.

Accordingly, it is desirable to provide a hitch system which will automatically couple and uncouple a tongue portion of a pulling vehicle with respect a drawbar portion of a trailing vehicle.

Of course, it is also desirable that the automatic hitch system be capable of attachment to existing equipment without modifications to the existing equipment.

A number of attempts have been made to provide hitch assemblies. These hitch assemblies usually have some type of system to guide the tongue portion of the pulling vehicle to the drawbar portion of the trailing vehicle where the vehicles are coupled.

A search of prior art records has unveiled the following patents:

1. CA 2,086,688 issued in 2001 to Bergman;
2. CA 2,413,766 registered in 2001 to Hall;
3. CA 2,158,736 registered in 1994 to Gingerich;
4. U.S. Pat. No. 5,873,595 issued in 1999 to Hinte;
5. U.S. Pat. No. 4,998,745 issued in 1991 to David;
6. U.S. Pat. No. 5,489,112 issued in 1996 to Warrington; and
7. U.S. Pat. No. 5,738,176 issued in 1998 to Gingerich.

### SUMMARY OF THE INVENTION

It is an object of the present invention is to provide a hitch system which is capable to automatically couple or uncouple a pulling vehicle with a trailing vehicle without the need of the driver to get out of the pulling vehicle.

More specifically, in accordance with the present invention, there is provided a first hitch section to be mounted on a pulling vehicle to be hitched to a second hitch section mounted on a trailing vehicle, which allow the automatic positioning, coupling and uncoupling of the pulling vehicle with respect to the trailing vehicle.

The first hitch section of the invention comprises a bottom channel to receive the extending tongue portion of the pulling vehicle. The bottom channel includes at its lower end a lever with contact flanges to fold up a foot member underneath the extending drawbar of the trailing vehicle.

A hitch pin with pull handle passes through an aperture drilled on the top surface of an horizontal upper plate welded thereon the bottom channel, an aperture drilled on the forwardly tongue portion of the pulling vehicle, and of which the hitch pin is vertically aligned with an aperture drilled through the bottom of the channel.

A plurality of horizontally aligned apertures are drilled through the both sides of the bottom channel. These apertures receive a threaded rod for adjusting the extending tongue portion of the pulling vehicle by displacing a plurality of washers interposed along the threaded rod being fixed thereby means of a nut screwed on the threaded bolt. On the top surface of the upper plate and at its rear portion, a structural body member is mounted and welded thereon. The body member includes at its rear portion a pair of holes for connecting a chain, and at its front portion an aperture to receive a pivot pin being welded on the top surface of the upper plate and on which is pivotally mounted a locking member and washer being blocked thereby a safety pin inserted therein hole formed through the pivot pin.

A locking pin locks a first end of the chain therein the first hole drilled through the structural body member. Again, a safety clip locks a second end of the chain therein the second hole also drilled therethrough and of which engaging the structural body member.

Once again on the top surface of the upper plate, a pin is also mounted for blocking the structural body member thereon.

Again at the front portion of the structural body member, a hole is also drilled therethrough for connecting a pulley by means of a blocking pin, and of which a cable turning around is engaged therein hole drilled through an elongated rectangular plate and fixed therein.

A tension spring is wound on a threaded rod passing through an aperture drilled through the elongated rectangular plate, and of which the tension spring is disposed between the rectangular plate and a rectangular block.

During the coupling operation a part member welded thereon the front portion of the upper plate, blocks the locking member when the tension spring applies a pressure on the rectangular block in an angular notch formed in the edge of the locking member to be locked with a vertical hitch pin being guided by a V-shaped cut toward a rounded recess being formed with the front portion of the upper plate.

The present invention also relates to a second hitch section to be mounted on a trailing vehicle to be hitched to the first hitch section.

The second hitch section according to the invention comprises the vertical hitch pin being welded thereon the top surface of a body member of which the vertical hitch pin passes through corresponding aligned apertures of a U-shaped bracket engaged thereon, and of which the forwardly drawbar portion of the trailing vehicle is welded therein the U-shaped bracket.

The upper end of the vertical hitch pin is threaded to receive a nut, and a washer is interposed between nut and the top surface of the U-shaped bracket.

The body member includes a pair of grooves which are capable to receive one first end of each tension spring which are assembled with a plurality of components being mounted on a threaded rod passing through each opening drilled through each parallel mounting plate to be engaged therein each aperture of a central pivot located underneath the front portion of the body member and being fixed thereby a nut screwed thereon the threaded rod.

The second end of the tension springs is blocked therein a groove being formed with the top surface of each parallel mounting plate.

The foot member is provided with a pair of side plate portions defining of the inside a V-shaped and welded thereon a lower plate.

The parallel mounting plates having aligned apertures drilled therethrough and defining of the inside a V-shaped, are engaged thereon each side plate portion by a plurality of bolts and nuts therein aligned apertures drilled through the both side plate portions to be adjusted and aligned in height with the lever folding up the foot member underneath the extending drawbar of the trailing vehicle.

During the uncoupling operation the driver pulls a cable that is securely installed into the pulling vehicle to withdraw the rectangular block from the angular notch of which enabling rotation of the locking member about the pivot pin to be unlocked from the vertical hitch pin, and which moves forward with the pulling vehicle to release the lever from the foot member which is capable of returning downwards by the tension force produced through the springs.

The objects, advantages and other features of the present invention will become more apparent upon reading of the following non restrictive description of preferred embodiments thereof, given by way of example only with reference to the accompanying drawings.

### BRIEF DESCRIPTION OF THE DRAWING

In the appended drawings:

FIG. 1 is a perspective view of an automatic hitch system in an uncoupled position in accordance with the present invention;

FIG. 2 is a perspective view of the automatic hitch system shown in FIG. 1 in a coupled position;

FIG. 3 is a perspective view of a first hitch section of the automatic hitch system;

FIG. 4 is an exploded view of FIG. 3;

FIG. 5 is a perspective view of a second hitch section of the automatic hitch system;

FIG. 6 is an exploded view of FIG. 5;

FIG. 7 is a front elevational view of the automatic hitch system shown in FIG. 1 in an uncoupled position;

FIG. 8 is a front elevational view of the automatic hitch system shown in FIG. 2 in an intermediate position during coupling; and

FIG. 9 is a front elevational view of the automatic hitch system shown in FIG. 2 in a coupled position.

### DETAILED DESCRIPTION OF THE PREFERRED EMBODIMENTS

The automatic hitch system in accordance with the present invention comprises a first hitch section and a second hitch section. In the appended drawings, the first hitch section and the second hitch section are generally identified by the references B and D, respectively.

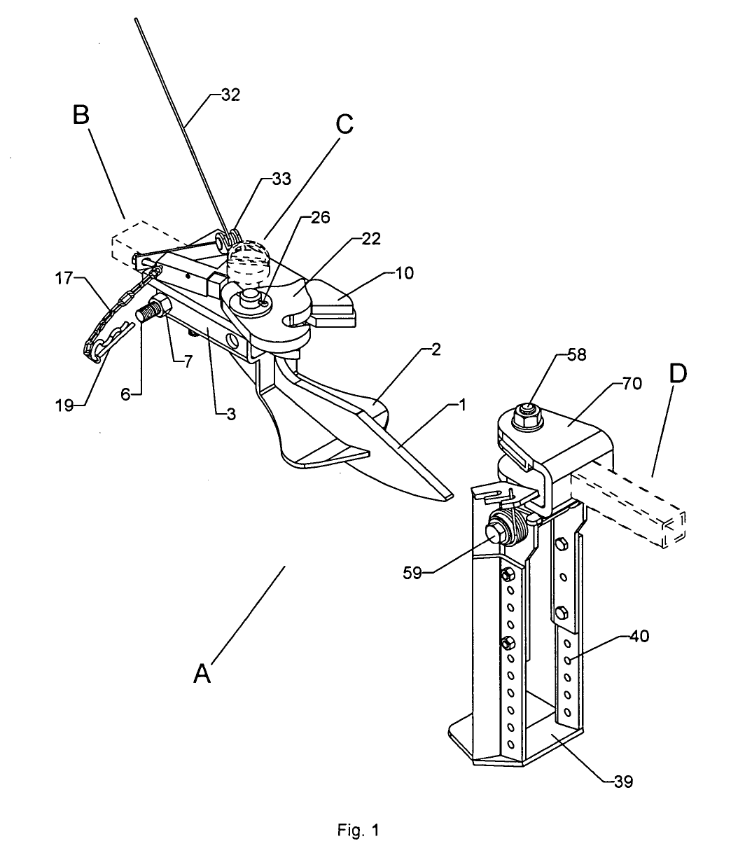

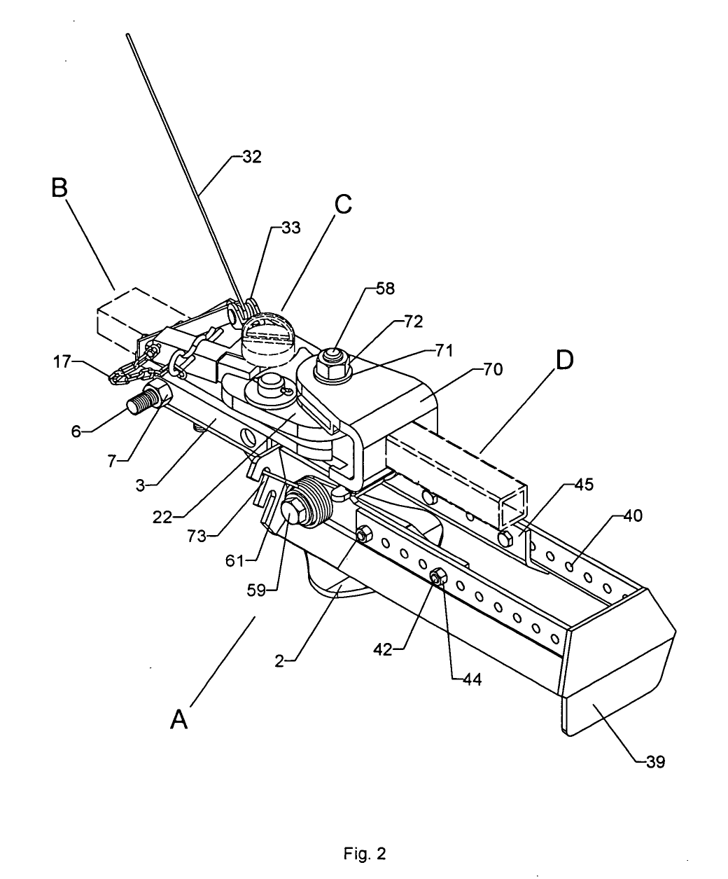

As illustrated in FIGS. 1 to 2, an automatic hitch system is shown generally at A for coupling a pulling vehicle, such as a tractor, to a trailing vehicle, such as a trailer or farm implement (not shown).

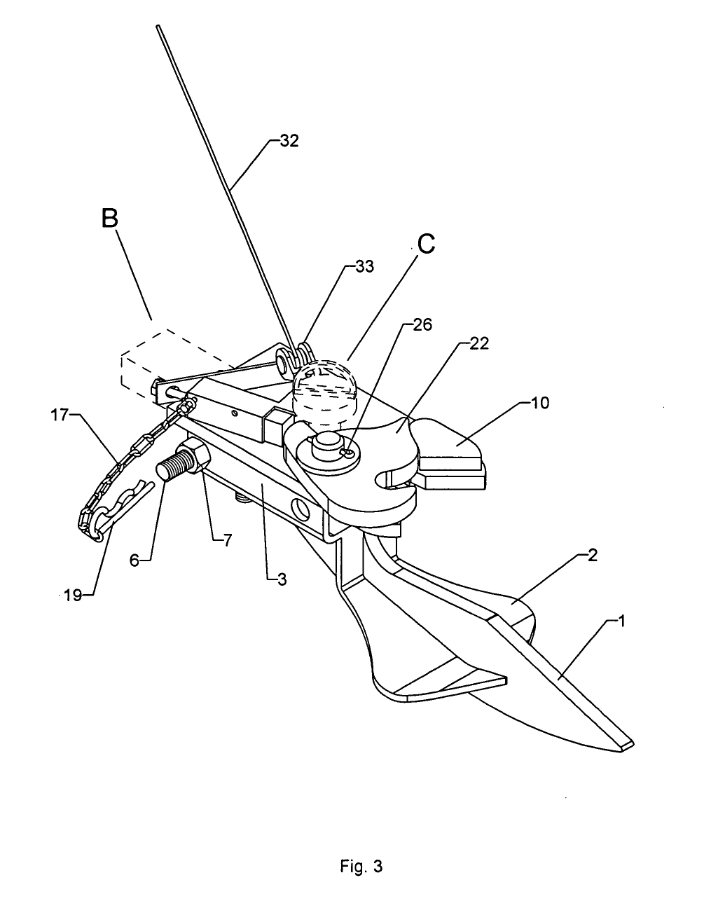

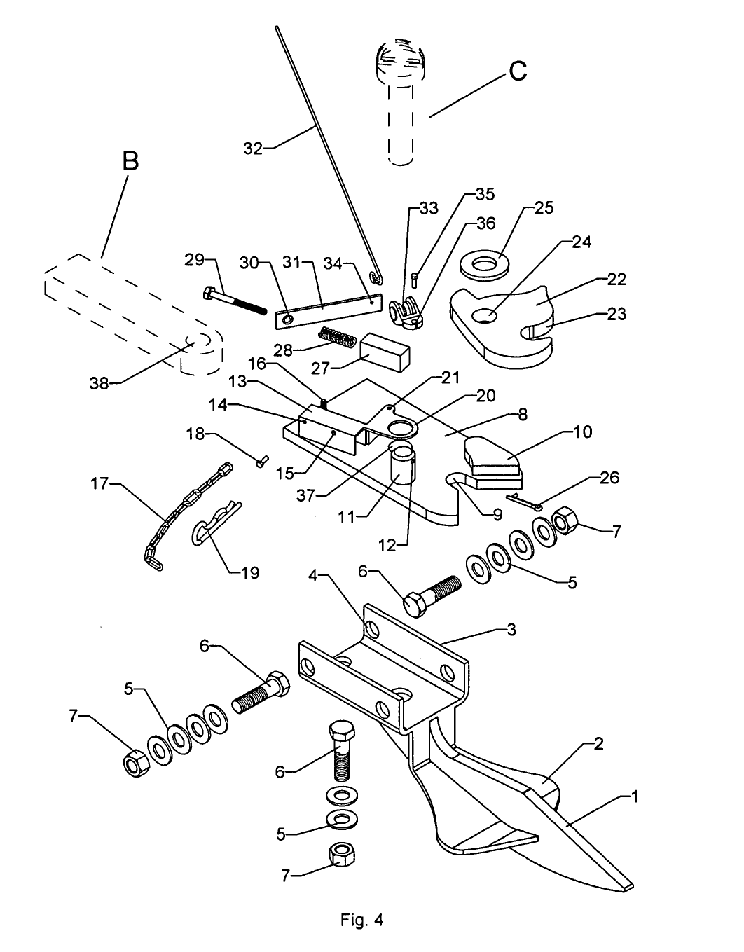

Referring to the drawings and FIGS. 1 to 4 in particular, the first hitch section B comprises a bottom channel (3) to receive the extending tongue portion of the pulling vehicle. The bottom channel (3) includes at its lower end a lever (1) with contact flanges (2) for folding up a foot member (39) underneath the extending drawbar portion of the trailing vehicle during the coupling operation.

A hitch pin with pull handle (C) passes through an aperture (37) drilled on the top surface of an horizontal upper plate (8) welded thereon the bottom channel (3), an aperture drilled on the forwardly tongue portion of the pulling vehicle, and of which the hitch pin is vertically aligned with an aperture (4) drilled through the bottom of the channel (3).

A plurality of horizontally aligned apertures (4) are drilled through the both sides of the bottom channel (3). These apertures (4) receive a threaded rod (6) for adjusting the extending tongue portion of the pulling vehicle by displacing a plurality of washers (5) interposed along the threaded rod (6) being fixed thereby means of a nut (7) screwed on the threaded bolt (6). On the top surface of the upper plate (8) and at its rear portion, a body member (13) is mounted and welded thereon. The body member (13) includes at its rear portion a pair of holes (14)(15) for connecting a chain (17), and at its front portion an aperture (20) to receive a pivot pin (11) being welded on the top surface of the upper plate (8) and on which is pivotally mounted a locking member (22) and washer (25) being blocked thereby a safety pin (26) inserted therein hole (12) drilled through the pivot pin (11).

A locking pin (18) locks a first end of the chain (17) therein the first hole (14) drilled through the body member (13). A safety clip (19) locks a second end of the chain (17) therein the second hole (15) also drilled therethrough and of which engaging the body member (13).

Again on the top surface of the upper plate (8), a pin (16) is also mounted for blocking the structural body member (13) thereon.

Again at the front portion of the structural body member (13), a hole (21) is also drilled therethrough for connecting a pulley (33) by means of a blocking pin (35), and of which a cable (32) turning around is engaged therein hole (34) drilled through an elongated rectangular plate (31) and fixed therein.

A tension spring (28) is wound on a threaded rod (29) passing through an aperture (30) drilled through the elongated rectangular plate (31), and of which is disposed between the rectangular plate (31) and a rectangular block (27).

During the coupling operation a part member (10) welded thereon the front portion of the upper plate (8), blocks the locking member (22) when the tension spring (28) applies a pressure on the rectangular block (27) in an angular notch formed in the edge of the locking member (22) to be locked with a vertical hitch pin (58) being guided by a V-shaped cut toward a rounded recess being formed with the front portion of the upper plate (8).

The present invention also relates to a second hitch section (D) to be mounted on a trailing vehicle to be hitched to the first hitch section (B).

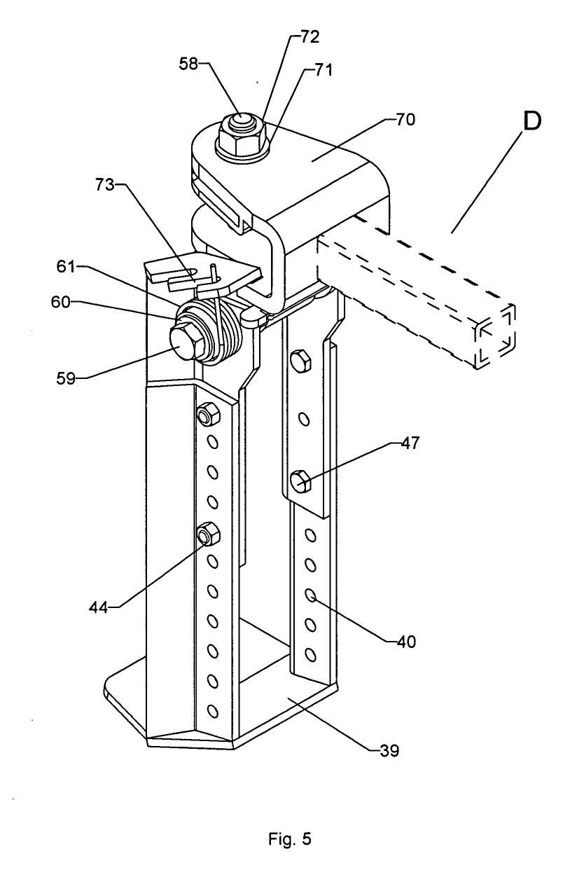

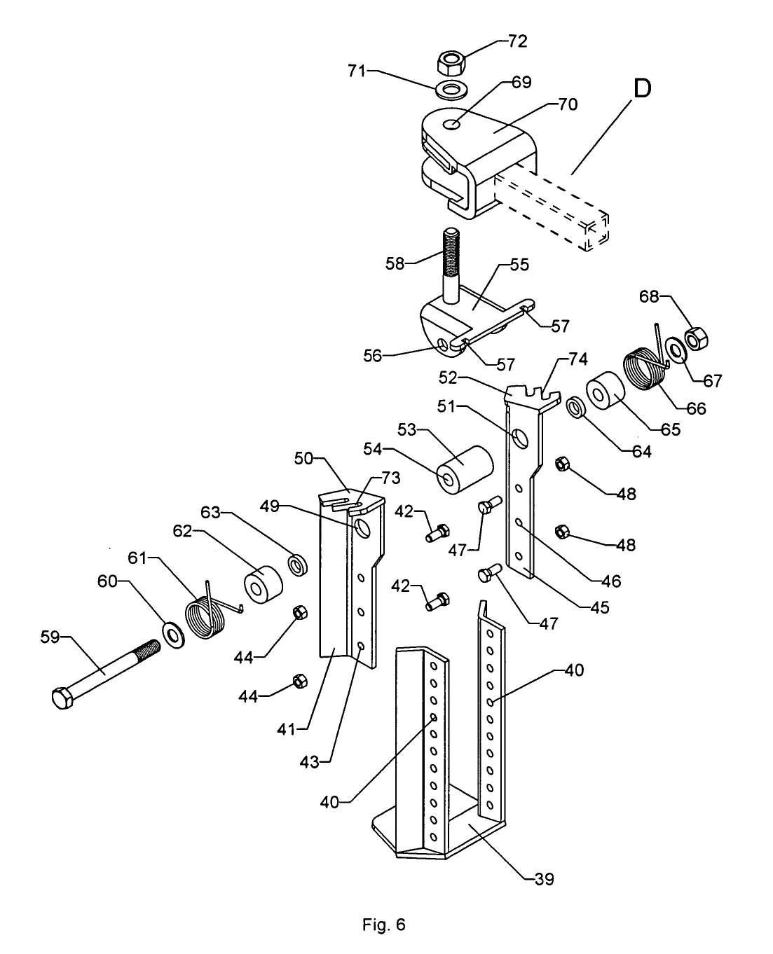

Referring to the drawings and FIGS. 1, 2, 5 and 6 in particular, the second hitch section D according to the invention comprises the vertical hitch pin (58) being welded thereon the top surface of a body member (55) of which the vertical hitch pin (58) passes through corresponding aligned apertures (69) of a U-shaped bracket (70) engaged thereon, and of which the forwardly drawbar portion of the trailing vehicle is welded therein the U-shaped bracket (70).

The upper end of the vertical hitch pin (58) is threaded to receive a nut (72), and a washer (71) is interposed between nut (72) and the top surface of the U-shaped bracket (70).

The body member (55) includes a pair of grooves (57) which are capable to receive one first end of each tension spring (61)(66) which are assembled with a plurality of components (60)(62)(63)(64)(65)(67) being mounted thereon a threaded rod (59) passing through each opening (49)(51) drilled through each parallel mounting plate (41)(45) to be engaged therein each aperture (54) of a central pivot (53) located underneath the front portion of the body member (55) and being fixed thereby a nut (68) screwed thereon the threaded rod (59).

The second end of each tension spring (61)(66) is blocked therein a groove (73)(74) being formed with the top surface (50)(52) of the parallel mounting plates (41)(45).

The foot member (39) is provided with a pair of side plate portions defining of the inside a V-shaped and welded thereon a lower plate.

The parallel mounting plates (41)(45) having aligned apertures (43)(46) drilled therethrough and defining of the inside a V-shaped, are engaged thereon each side plate portion by a plurality of bolts (42)(47) and nuts (44)(48) therein aligned apertures (40) drilled through the both side plate portions to be adjusted and aligned in height with the lever (1) folding up the foot member (39) underneath the extending drawbar of the trailing vehicle.

During the uncoupling operation the driver pulls a cable (32) that is securely installed into the pulling vehicle to withdraw the rectangular block (27) from the angular notch of which enabling rotation of the locking member (22) about the pivot (11) to be unlocked from the vertical hitch pin (58), and which moves forward with the pulling vehicle to release the lever (1) from the foot member (39) which is capable of returning downwards by the tension force produced through the springs (61)(66).

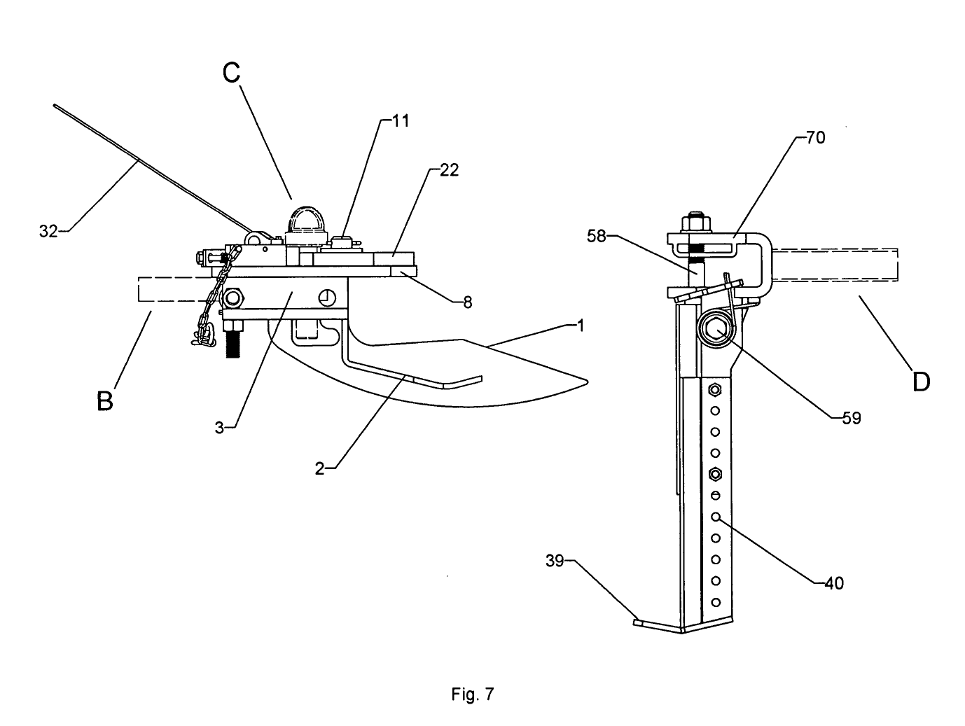

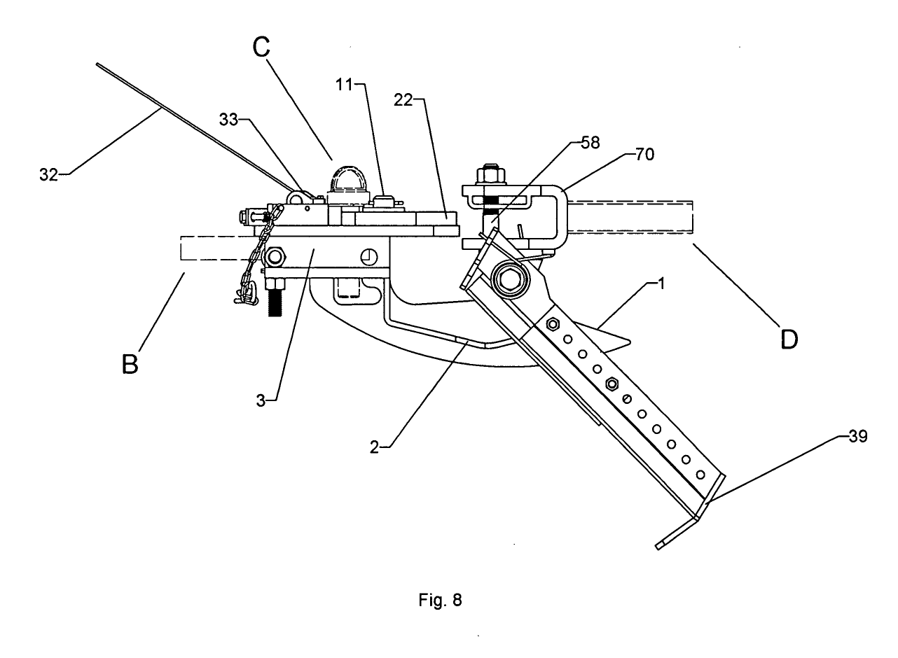

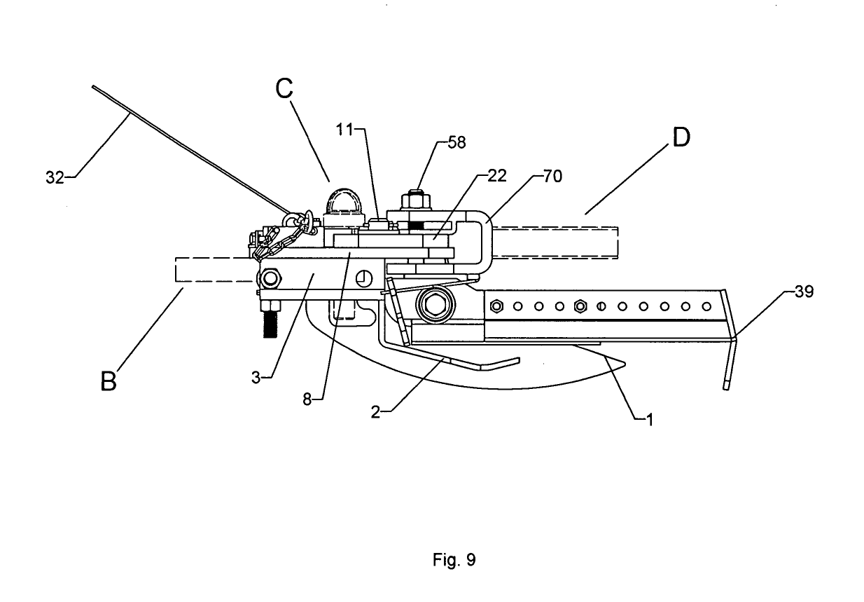

Referring to the drawing and FIGS. 7, 8 and 9 specifically, it is shown the automatic hitch system (A) in its coupled and uncoupled position.

Whereas, the present invention has been described in relation to the drawings attached hereto, it should be understood that other and further modifications, apart from those shown or suggested herein, may be made within the spirit and scope of this invention.

What is claimed is:

1. An automatic system for hitching to a pulling vehicle a trailing vehicle, comprising a first hitch section to be mounted on said pulling vehicle and a second hitch to be mounted on said trailing vehicle, wherein said first hitch section comprises:
a bottom channel (3) to receive the extending tongue portion of the pulling vehicle;
a hitch pin with pull handle (C) passing through an aperture (37) drilled on the top surface of an horizontal upper plate (8) welded thereon said bottom channel (3), an aperture drilled on the forwardly tongue portion of the pulling vehicle, and of which the hitch pin is vertically aligned with an aperture (4) drilled through the bottom of said channel (3);
a structural body member (13) mounted on the top surface of the upper plate (8) and welded thereon;
a pin (16) mounted and welded on the top surface of said upper plate (8) for blocking said body member (13) thereon; and
a part member (10) mounted and welded thereon the front portion of said upper plate (8) for blocking a locking member (22) when a tension spring (28) applies a pressure on a rectangular block (27) in an angular notch formed in the edge of the locking member (22) to be locked with a vertical hitch pin (58) being guided by a V-shaped cut toward a rounded recess being formed with the front portion of said upper plate (8), and when uncoupling the driver pulls a cable (32) that is securely installed into the pulling vehicle to withdraw the rectangular block (27) from the angular notch of which enabling rotation of the locking member (22) about a pivot (11) to be unlocked from the vertical hitch pin (58), and which moves forward with the pulling vehicle to release a lever (1) from a foot member (39) which is capable of returning downwards by the tension force produced through each spring (61)(66).

2. A first hitch section as recited in claim 1, wherein said bottom channel (3) includes at its lower end the lever (1) with contact flanges (2) for folding up the foot member (39) underneath the extending drawbar of the trailing vehicle.

3. A first hitch section as recited in claim 1, wherein said bottom channel (3) includes horizontally aligned apertures (4) drilled through the both sides of said bottom channel (3) to receive a threaded rod (6) for adjusting the extending tongue portion of the pulling vehicle by displacing a plurality of washers (5) interposed along the threaded rod (6) being fixed thereby means of a nut (7) screwed on said threaded bolt (6).

4. A first hitch section as recited in claim 1, wherein said body member (13) includes at its rear portion a pair of holes (14)(15) for connecting a chain (17), and at its front portion an aperture (20) to receive the pivot pin (11) being welded on the top surface of said upper plate (8) and on which is pivotally mounted the locking member (22) and washer (25) being blocked thereby a safety pin (26) inserted therein hole (12) drilled through said pivot pin (11).

5. The structural body member as recited in claim 4, in which a locking pin (18) locks a first end of the chain (17) therein the first hole (14) drilled through said structural body member (13).

6. The structural body member as recited in claim 4, in which a safety clip (19) locks a second end of the chain (17) therein the second hole (15) drilled through said body member (13), and of which the safety clip (19) is engaged onto said body member (13).

7. The structural body member as recited in claim 1, in which a hole (21) is drilled through the front portion of said body member (13) for connecting a pulley (33) by means of a blocking pin (35), and of which the cable (32) turning around is engaged therein hole (34) drilled through an elongated rectangular plate (31) and fixed therein.

8. The cable as recited in claim 7, which is securely installed into the pulling vehicle so as to prevent said locking member (22) be accidentally unlocked from said vertical hitch pin (58) for coupling the forwardly drawbar portion of the trailing vehicle.

9. The elongated rectangular plate as recited in claim 7, in which an aperture (30) is drilled therethrough to receive a threaded rod (29) on which a tension spring (28) is wound and disposed between the rectangular plate (31) and said rectangular block (27).

10. The second hitch section as recited in claim 1, wherein said second hitch section (D) to be coupled on the trailing vehicle to be hitched to the first hitch section (B), and which comprising:
said vertical hitch pin (58) being welded thereon the top surface of a body member (55);
said vertical hitch pin (58) passes through corresponding aligned apertures (69) of a U-shaped bracket (70) engaged thereon, and of which the forwardly drawbar portion of the trailing vehicle is welded therein said U-shaped bracket (70); and
the upper end of said vertical hitch pin (58) is threaded to receive a nut (72), and a washer (71) is interposed between nut (72) and the top surface of said U-shaped bracket (70).

11. The body member as recited in claim 10, includes a pair of grooves (57) which are capable to receive one first end of the tension springs (61)(66) which are assembled with a plurality of components (60)(62)(63) (64)(65)(67) being mounted thereon a threaded rod (59) passing through each opening (49)(51) drilled through each parallel mounting plate (41)(45) to be engaged therein each aperture (54) of a central pivot (53) located underneath the front portion of said body member (55) and being fixed thereby a nut (68) screwed thereon the threaded rod (59).

12. The parallel mounting plates as recited in claim 11, wherein the second end of said tension springs (61)(66) is blocked therein a groove (73)(74) being formed with the top surface (50)(52) of said parallel mounting plates (41)(45).

13. The second hitch section as recited in claim 10, further includes a foot member (39) which is provided with a pair of side plate portions defining of the inside a V-shaped and welded thereon a lower plate.

14. The parallel mounting plates as recited in claim 11 or 12, further includes having aligned apertures (43)(46) drilled therethrough and defining of the inside a V-shaped, are engaged thereon each side plate portion by a plurality of bolts (42)(47) and nuts (44)(48) therein aligned apertures (40) drilled through the both side plate portions to be adjusted and aligned in height with the lever (1) folding up the foot member (39) underneath the extending drawbar of the trailing vehicle.
